(19) United States
(12) Patent Application Publication
(10) Pub. No.: US 2024/0296536 A1
(43) Pub. Date: Sep. 5, 2024

(54) TUNNEL DYNAMIC BLASTING DEVICE BASED ON GEOLOGICAL BODY INTELLIGENT PERCEPTION, SYSTEM AND METHOD

(71) Applicant: SHENYANG UNIVERSITY OF TECHNOLOGY, Shenyang (CN)

(72) Inventors: Junxiang Wang, Dalian (CN); Jiaxin Wu, Fuxin (CN); Lianjun Guo, Anshan (CN); Baokuan Ning, Shenyang (CN); Sili Chen, Shenyang (CN); Gang Sun, Datong (CN)

(21) Appl. No.: 18/298,182

(22) Filed: Apr. 10, 2023

(30) Foreign Application Priority Data
Mar. 3, 2023 (CN) 2023101964022

(51) Int. Cl. G06T 7/00; E21D 9/14; F42D 3/04; F42D 99/00; G06F 30/20; G06T 7/13; G06T 15/10

(52) U.S. Cl. CPC G06T 7/0002; E21D 9/14; F42D 3/04; F42D 99/00; G06F 30/20; G06T 7/13; G06T 15/10; E21D 9/006; G06F 2111/10; G06T 2207/10028; G06T 2207/30181; G06T 2207/30242; G06T 2210/56

(57) ABSTRACT

A tunnel dynamic blasting device based on geological body intelligent perception, a system and a method are provided. A blasting design instrument body of the tunnel dynamic blasting device is disposed with a 3D laser scanning device, a digital camera device, a borehole locating device, an electronic screen, a built-in computer and a wireless communication device. The 3D laser scanning device, the digital camera device, the borehole locating device, the electronic screen and the wireless communication device are connected to the built-in computer. A housing of the blasting design instrument body is disposed with a battery compartment having a lithium battery secured therein. A range finder is secured above the housing. Problems of non-systematicness and lag of tunnel blasting design and coarseness of borehole locating nowadays are solved, thus the tunnel excavation efficiency and borehole arrangement accuracy in the tunnel cross-section are improved, thereby improving the tunnel blasting quality.

### TECHNICAL FIELD

The invention relates to the field of information-based and intelligent design and construction of tunnels and underground engineering, and particularly to a tunnel dynamic blasting device based on geological body intelligent perception, a design system and a blasting method.

### BACKGROUND

Informatization and intellectualization have become an inevitable trend of mountain tunnel construction. How to design a blasting construction scheme in accordance with local conditions and break through the dilemma of “diametrically opposed to each other” between a design scheme and an on-site situation resulting from parameter adjustment by personal experience has become the focus of current research.

With the rapid development of modern society, there is a higher demand for the convenience of transportation, and the transportation network has become an important lifeblood for maintaining a stable development of national economy.

Therefore, the state continues to carry out transportation network planning in response to demands for transportation network, and increases the construction of transportation network year by year. Due to geographical conditions in China that there are many mountainous areas, the way of tunnel construction is usually used when encountering mountains. At present, a main method of tunnel engineering excavation is a drilling-blasting method, which has advantages such as strong geological adaptability, low excavation cost, and convenient and flexible construction. However, a blasting scheme design of the drilling-blasting method mostly depends on engineering experience and engineering analogy to design blasting parameters and arrange boreholes, which lacks theoretical and technical guidance. Due to the complexity of blasting mechanism, the lag of blasting theory, the lack of blasting professional design software and measurement tools, and the insufficient quality of operators, the tunnel blasting technology level is generally extensive, the blasting design generally depends on experience or semi-experience, lacking of quantitative analysis, blasting operators often rely on experience to construct with large randomness and serious over-excavation and under-excavation, and thus blasting quality and effect are difficult to control. In a process of tunnel blasting construction, a traditional way of locating boreholes on a tunnel face is to use an electronic total station to set out several key perimeter-hole positions, and then on-site workers dispose cut-holes, reliever-holes and perimeter-holes according to their past experiences. Due to the randomness of hole arrangement, sizes of rock blocks after blasting on-site are discrete, making it difficult to directly reuse them, and inaccurate spacing and positions of the perimeter-holes lead to significant over-excavation and under-excavation in blasting. Therefore, blasting parameters cannot be adjusted timely and effectively in the face of dynamic changes in engineering geology, which not only affects the construction progress, but also leads to accidents. Moreover, the accuracy of borehole arrangement directly affects the quality of excavation by blasting, and thus it is necessary to arrange boreholes according to demonstrated blasting design requirements.

### SUMMARY

The invention provides a tunnel dynamic blasting device based on geological body intelligent perception, a system and a method, and aims to solve problems of non-systematicness and lag of tunnel blasting design and coarseness of borehole locating nowadays, so as to improve the tunnel excavation efficiency and borehole arrangement accuracy in the tunnel cross-section and thereby improve the tunnel blasting quality.

In view of the above problems, the invention aims to provide a tunnel dynamic blasting design device based on geological body intelligent perception, a system and a method, technical solutions of embodiments of the invention are as follows.

In a first aspect, the invention provides a tunnel dynamic blasting device based on geological body intelligent perception. A blasting design instrument body of the tunnel dynamic blasting device is rotatably mounted on a top end of a pedestal, a bottom end of the pedestal is mounted on a four-wheel drive, and a lithium battery is secured on the blasting design instrument body. A three-dimensional laser scanning device, a digital camera device, a borehole locating device, a built-in computer and a wireless communication device are disposed in a housing of the blasting design instrument body. The three-dimensional laser scanning device, the digital camera device, the borehole locating device and the wireless communication device are connected to the built-in computer. A battery compartment is disposed in the housing, and the lithium battery is secured in the battery compartment. An electronic screen is disposed outside the housing and connected to the built-in computer, and a range finder is mounted above the housing. Moreover, an incline compensator is mounted at a bottom of the housing.

In another aspect, the invention provides a design system of a tunnel dynamic blasting device based on geological body intelligent perception. The system includes: a geological body intelligent perception module, a tunnel intelligent dynamic blasting design and parameter optimization module, a blasting dynamic fracture behavior analysis module, a laser scanning blasting effect quality evaluation module and a borehole layout module. The tunnel intelligent dynamic blasting design and parameter optimization module is individually connected to the geological body intelligent perception module, the blasting dynamic fracture behavior analysis module, the laser scanning blasting effect quality evaluation module and the borehole layout module. The geological body intelligent perception module is configured (i.e., structured and arranged) to identify a surrounding rock mass. The tunnel intelligent dynamic blasting design and parameter optimization module is configured to design tunnel blasting parameters and optimize the tunnel blasting parameters according to an evaluation result of the laser scanning blasting effect quality evaluation module. The blasting dynamic fracture behavior analysis module is configured to perform numerical simulation on the tunnel blasting parameters designed by the tunnel intelligent dynamic blasting design and parameter optimization module and a borehole layout generated by the borehole layout module, to preliminarily check rationality of the tunnel blasting parameters and the borehole layout. The laser scanning blasting effect quality evaluation module is configured to perform noise reduction and analysis on point cloud data obtained by a three-dimensional laser scanning device in operation to obtain tunnel blasting excavation result, evaluate the tunnel blasting excavation result to obtain the evaluation result, and transmit the evaluation result to the tunnel intelligent dynamic blasting design and parameter optimization module. The borehole layout module is configured to automatically generate the borehole layout according to a crack of a tunnel face and the tunnel blasting parameters designed by the tunnel intelligent dynamic blasting design and parameter optimization module, and transmit the borehole layout to a projection device (e.g., a borehole locating device). Moreover, in an exemplary embodiment, the geological body intelligent perception module, the tunnel intelligent dynamic blasting design and parameter optimization module, the blasting dynamic fracture behavior analysis module, the laser scanning blasting effect quality evaluation module and the borehole layout module are software modules stored in one or more memories and executable by one or more processors coupled to the one or more memories.

In an embodiment, the geological body intelligent perception module is configured to match explosives according to identified lithologic information of the surrounding rock mass to make a characteristic impedance of the explosives be matched with a characteristic impedance of rock.

In still another aspect, the invention provides a blasting method of a tunnel dynamic blasting device based on geological body intelligent perception, including:
step 1, acquiring position information of a tunnel face and transmitting the position information to a built-in computer, by a blasting design instrument body;
step 2, performing three-dimensional laser scanning on the tunnel face to generate a point cloud image of a vicinity of the tunnel face and transmitting information data of the point cloud image to a geological body intelligent perception module in the built-in computer, by a three-dimensional laser scanning device; performing multi-view based three-dimensional reconstruction on the information data of the point cloud data and inputting surrounding rock information after the reconstruction to a tunnel intelligent dynamic blasting design and parameter optimization module in the built-in computer, by the geological body intelligent perception module; acquiring edge features of the tunnel face, determining an identified region as a region of the tunnel face, identifying a type of a surrounding rock mass and joints and cracks of the surrounding rock mass within the tunnel face to obtain identified information and transmitting the identified information to the tunnel intelligent dynamic blasting design and parameter optimization module in the built-in computer, by a digital camera device;
step 3, selecting corresponding blasting design parameter influence values according to the surrounding rock information, substituting the influence values into a blasting design parameter formula to obtain tunnel blasting design parameters and transmitting the tunnel blasting design parameters to a borehole layout module in the built-in computer, by the tunnel intelligent dynamic blasting design and parameter optimization module;
step 4, obtaining a tunnel borehole layout according to the tunnel blasting design parameters and transmitting image information of the tunnel borehole layout to a memory of a borehole locating device, by the borehole layout module;
step 5, performing numerical simulation of a blasting process according to the tunnel blasting design parameters obtained by the tunnel intelligent dynamic blasting design and parameter optimization module and the tunnel borehole layout obtained by the borehole layout module, analyzing fracture behaviors of the surrounding rock mass under an action of blasting during the numerical simulation and ensuring fracture development of rock mass in each step during the numerical simulation is in a reasonable range, by a blasting dynamic fracture behavior analysis module in the built-in computer;
step 6, generating a borehole layout image according to borehole layout information in the memory and projecting borehole positions on the tunnel face for blasting, by an image controller of the borehole locating device; and step 7, after completion of tunnel blasting and slagging, performing three-dimensional laser scanning on the tunnel face after blasting to obtain a three-dimensional point cloud image after blasting and transmitting the three-dimensional point cloud image to a laser scanning blasting effect quality evaluation module in the built-in computer, by the three-dimensional laser scanning device; analyzing the three-dimensional point cloud image to obtain tunnel blasting quality result and transmitting the tunnel blasting quality result to the tunnel intelligent dynamic blasting design and parameter optimization module for parameter optimization, by the laser scanning blasting effect quality evaluation module.

In an embodiment, in the step 3, the tunnel blasting design parameters include: a borehole diameter (d), depths of boreholes (L), a number of boreholes (N), spacings of boreholes, design and layout of boreholes, a powder factor (k), quantity of explosives required for one excavation cycle (Q), and charges of boreholes.

In an embodiment, the depths of boreholes include: a cut-hole depth L_{ch}, a perimeter-hole depth Lₚₕ, and a reliever-hole depth Lᵣₕ;
a calculation formula of the cut-hole depth L_{ch} is as follows:

$${L}_{ch} = \frac{{L}_{0} / η + 0.2}{sin θ} ,$$

where, L₀ represents a tunnel excavation cyclic footage, η represents an efficiency of borehole, and θ represents an intersection angle between a cut-hole and an excavation face;
a calculation formula of the perimeter-hole depth Lₚₕ is as follows:

$${L}_{ph} = \frac{{L}_{0}}{η \times cos α} ,$$

where α represents an extrapolation angle of perimeter-hole;
a calculation formula of the reliever-hole depth Lᵣₕ is as follows:

$${L}_{rh} = \frac{{L}_{0}}{η} ;$$

a calculation formula of the number of boreholes (N) is as follows:

$$N = 3.3 \sqrt[3]{{fS}^{2}} ,$$

where, N represents the number of boreholes and a calculation result thereof is rounded to be an integer, ƒ represents a firmness coefficient of rock, namely, Protodyakonov's coefficient, ƒ=R_{c}/10, and R_{c} represents a uniaxial saturated compressive strength of rock, S represents an area of tunnel cross-section;
a calculation formula of the powder factor (k) is as follows:

$$k = 1.1 {k}_{0} \sqrt{\frac{f}{S}} ,$$

where, k represents the powder factor, k₀ represents an explosive power correction coefficient, k₀=525/P, and P represents a selected explosive power;
a calculation formula of the quantity of explosives required for one excavation cycle (Q) is as follows:

Q=kSLη,
where, L represents the depths of boreholes;
the charges of boreholes include: a single cut-hole charge Q_{schc}, a single perimeter-hole charge Q_{sphc}, and a single reliever-hole charge Q_{srhc};
a calculation formula of the single cut-hole charge Q_{schc} is as follows:

Q_{schc}=rnL_{ch},
where, r represents a weight of a cartridge with a length of 1 meter and is calculated as per cartridge specification of selected explosives, and n represents a charge coefficient of borehole;
a calculation formula of the single perimeter-hole charge Q_{sphc} is as follows:

Q_{sphc}=qₓLₚₕ,
where, qₓ represents a line charge density of perimeter-hole;
a calculation formula of the single reliever-hole charge Q_{srhc} is as follows:

Q_{srhc}=kabLᵣₕ,
where, α represents a hole spacing of reliever-hole, and b represents a row spacing of reliever-hole.

In an embodiment, in the step 5, the reasonable range refers to a number of reasonable boreholes accounts for 80%˜100% of a total number of boreholes; each of the reasonable boreholes refers to a borehole that according to impact of a relative position relationship between explosives and the borehole in the blasting process obtained based on a damping coefficient (c) of each the step on rock mass fracture development process, a development trend of a main crack in each the step is toward a neighboring borehole outside a contour line on which the borehole is located.

In an embodiment, a formula for solving the damping coefficient (c) is as follows:

$${c}^{n} = \sqrt[2]{[ {( {u}^{n} )}^{T} {K}^{n} {u}^{n} ] / [ {( {u}^{n} )}^{T} {u}^{n} ]} ,$$

where, u represents a displacement, Kⁿ represents a diagonal local stiffness matrix, and c represents the damping coefficient.

Compared with the prior art, the invention has stronger applicability and may have advantages as follows.
1. Changing the traditional manual calculation of blasting design parameters into intelligent automatic design of parameters, so that the tunnel blasting design can be completed on-site; by determining smooth blasting parameters by analyzing conditions of surrounding rock, tunnel geometric dimensions, excavation manner and other data, and constantly modifying blasting parameters according to actual blasting quality, flexible automatic design schemes to adapt to different environments can be finally formed, and thereby meeting different construction requirements. Therefore, it can greatly reduce the time of tunnel blasting design and setting-out, increase the accuracy of borehole layout, and improve the quality of blasting.
2. The automatic positioning used by the tunnel dynamic blasting device, by manually inputting an instrument coordinate point, can automatically find the coordinate point, and thereby realize automatic positioning of the tunnel dynamic blasting device. Compared with the positioning through the electronic total station, it is more rapid and convenient, thereby improving the efficiency of positioning and reducing time and cost.
3. The tunnel dynamic blasting device integrates various devices such as three-dimensional laser scanning, digital camera, and borehole locating, and has many functions such as surrounding rock identification, fracture identification, blasting design, borehole layout, borehole locating, quality evaluation and design optimization. The tunnel dynamic blasting device can be used throughout the whole process of design and construction of the tunnel drilling-blasting method, which reduces the personnel consumption and device volume, has a higher cost performance, and greatly realizes intellectualization of the tunnel blasting process.
4. The system integrates various stages of design, construction and quality evaluation of the whole process of tunnel excavation by the drilling-blasting method, and the integrated system can ensure that all the stages of excavation by the drilling-blasting method can be carried out coherently, thereby solving the problem of fault in connection caused by improper coordination, greatly reducing the time cost and the labor cost, and thus having high economic benefit.
5. The point cloud reconstruction and a dynamic relaxation method used in the numerical simulation in the blasting method are both relatively advanced theories at current stage, and the application of the theories to the tunnel blasting design and construction process is helpful to the technical progress, and has deep construction significance for the future development of the tunnel blasting design and construction.

As seen from the above advantages, the invention has great engineering significance in the tunnel blasting design and construction.

### BRIEF DESCRIPTION OF DRAWINGS

FIG. 1 illustrates a schematic view of a vehicle-mounted blasting design device based on geological body intelligent perception.

FIG. 2 illustrates schematic left and front views of a four-wheel drive.

FIG. 3 illustrates a schematic internal structure of the four-wheel drive.

FIG. 4 illustrates a schematic view of a blasting design instrument body.

FIG. 5 illustrates a schematic internal structure of the blasting design instrument body.

FIG. 6 illustrates a schematic internal structure of a three-dimensional laser scanning device.

FIG. 7 illustrates a schematic internal structure of a digital camera device.

FIG. 8 illustrates a schematic internal structure of a borehole locating device.

FIG. 9 illustrates a schematic connection diagram of various modules in a built-in computer.

FIG. 10 illustrates a schematic view of automatic positioning of a vehicle-mounted device at a tunnel site.

FIG. 11 illustrates a schematic flowchart of a blasting design system based on geological body intelligent perception.

FIG. 12 illustrates a schematic program flowchart of a peridynamic (PD) blasting dynamic fracture behavior analysis module.

FIG. 13 illustrates an effect of a geological body model formed by fusion of image technology with a 3D laser scanning point cloud model.

FIGS. 14A-14F illustrate schematic crack propagation diagrams of different time steps simulated by the blasting dynamic fracture behavior analysis module.

FIGS. 15A-15C illustrate schematic near-field force distribution cloud images of different time steps simulated by the blasting dynamic fracture behavior analysis module.

Description of reference numerals in the drawings: 1-blasting design instrument body, 2-pedestal, 3-four-wheel drive, 4-lithium battery, 5-accumulator, 101-frame, 102-suspension, 103-wheel, 104-electric motor, 106-transmission shaft, 107-steering system, 108-central control system, 201-housing, 202-three-dimensional laser scanning device, 203-digital camera device, 204-borehole locating device, 205-electronic screen, 206-built-in computer, 207-wireless communication device, 208-battery compartment, 209-range finder, 210-incline compensator, 301-laser radar, 302-speed sensor, 303-filter lens, 304-motor, 305-panoramic camera, 306-time counter, 307-central processor, 401-lens, 402-VCM motor (abbreviation for voice coil motor), 403-base, 404-infrared (IR) filter, 405-image sensor, 406-printed circuit board (PCB), 407-protective glass, 408-processor, 501-dustproof cover, 502-projection lens, 503-DLP (abbreviation for digital light processing) circuit board, 504-projection light source, 505-convergence lens, 506-color wheel, 507-correction lens, 508-memory, 509-image controller, 510-DMD (abbreviation for digital micromirror device) chip.

### DETAILED DESCRIPTION OF EMBODIMENTS

The invention will be further described in detail below with reference to the accompanying drawings and specific embodiments.

In combination with engineering examples, the invention proposes a tunnel dynamic blasting device based on geological body intelligent perception, a design system and a blasting method. The tunnel dynamic blasting device exemplarily includes a three-dimensional (3D) laser scanning device, a digital camera device, a borehole locating device, an embedded computer and so on. The tunnel dynamic blasting device has many functions such as surrounding rock identification, fracture quantitative identification, blasting design, automatic borehole locating, blasting effect quality rating, design parameter feedback adjustment, and so on. It can greatly improve the efficiency of tunnel blasting design, improve the blasting quality control system, reduce over-excavation and under-excavation caused by blasting, realize dynamic blasting design, and improve the blasting quality. Combining with applications of intelligent tunnel construction devices, standardized, process-oriented, information-based and intelligent tunnel construction schemes can be formed, the construction efficiency can be improved, and the idea of tunnel construction is changed from traditional off-line experience decision-making to AI (abbreviation for artificial intelligence) data intelligent decision-making, thereby fully exploring digital potentiality of tunnels and helping enterprises to reduce costs and increase efficiency.

### Embodiment 1

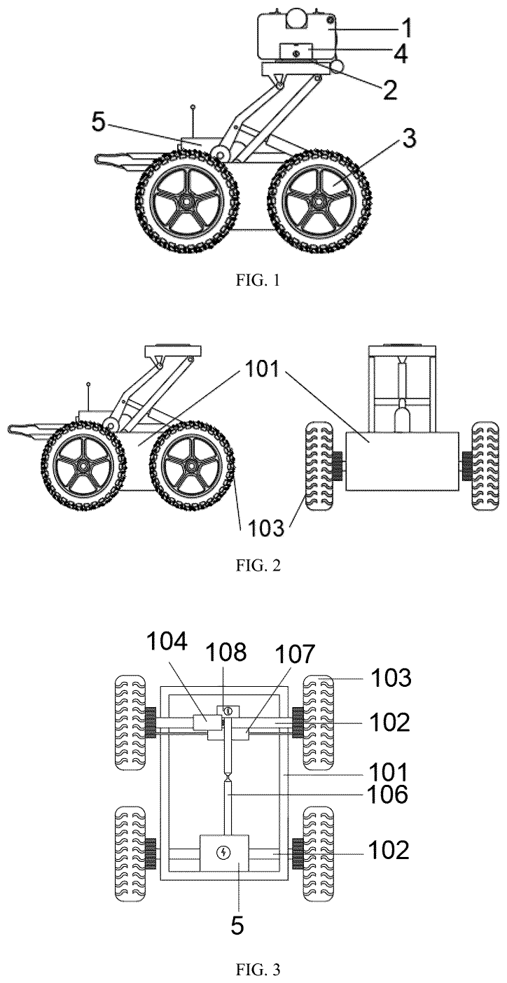

As illustrated in FIG. 1, in an aspect, the invention provides a tunnel dynamic blasting device based on geological body intelligent perception, which is mainly used for a blasting design of tunnel excavation by a drilling-blasting method and one-time full boreholes locating, so that efficiency of tunnel blasting design is accelerated, the accuracy of borehole arrangement is improved, and the tunnel blasting design process is improved. Specifically, the tunnel dynamic blasting device mainly includes a blasting design instrument body 1, a pedestal 2, a four-wheel drive 3, and a lithium battery 4. The blasting design instrument body 1 is rotatably mounted on a top end of the pedestal 2, a bottom end of the pedestal 2 is mounted on the four-wheel drive 3, the lithium battery 4 is fixed on the blasting design instrument body 1, and the blasting design instrument body 1 is powered by the lithium battery 4.

As illustrated in FIG. 2 and FIG. 3, the four-wheel drive 3 is a 3600 automatically located four-wheel drive. The four-wheel drive 3 includes a frame 101, suspensions 102, wheels 103, an electric motor 104, an accumulator 5, a transmission shaft 106, a steering system 107 and a central control system 108. The frame 101 is formed by a rectangular steel rack, a bottom of which is provided with a bottom plate and a top part of which is provided with a telescopic support. The pedestal 2 is arranged on the telescopic support. The suspensions 102 are divided into two parts, i.e., a front suspension and a rear suspension, which are respectively fixed on front and rear ends of the frame 101. The wheels 103 are mounted on both sides of the front and rear suspensions. The accumulator 5 is secured on the rear suspension and used to power the electric motor 104. The electric motor 104 is secured on the front suspension. The transmission shaft 106 is disposed in the frame 101, and is connected with the accumulator 5 and the electric motor 104. The steering system 107 is disposed on a rear side of the front suspension and configured (i.e., structured and arranged) to mainly control the steering of front wheels. The central control system 108 is disposed below the pedestal 2, a built-in chip thereof has a signal transmitter, and the central control system is connected with the blasting design instrument body 1 by transmitting a 5G network signal through the signal transmitter. A location tracker in the built-in chip is located on a center of the blasting design instrument body 1, and whether the four-wheel drive 3 stays at a required coordinate point is determined by the location tracker. The built-in chip is configured to control the four-wheel drive 3 to do pathfinding automatically by reading set location point coordinates and coordinates corresponding to a current position where it locates, so as to realize the automatic locating function. In an illustrated embodiment, a size of the 3600 automatically located four-wheel drive 3 is 1 m×1 m, the 3600 automatically located four-wheel drive 3 includes the automatically adjusted telescopic support, the pedestal 2 is arranged on the top end of the telescopic support, the pedestal 2 can secure the blasting design instrument body 1 thereon, the 3600 automatically located four-wheel drive 3 is connected to the blasting design instrument body 1 through a connection cable, and after connection, the 3600 automatically located four-wheel drive 3 can perform automatic pathfinding and locating based on coordinates input into the blasting design instrument body 1.

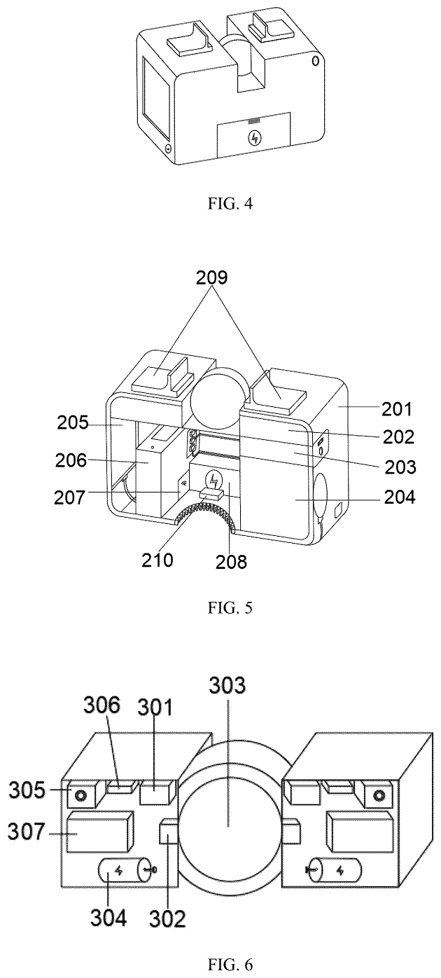

As illustrated in FIG. 4 and FIG. 5, the blasting design instrument body 1 includes a housing 201, a 3D laser scanning device 202, a digital camera device 203, a borehole locating device 204, an electronic screen 205, a built-in computer 206, a wireless communication device 207, a battery compartment 208, a range finder 209, and an incline compensator 210. The 3D laser scanning device 202, the digital camera device 203, the borehole locating device 204, the electronic screen 205 and the wireless communication device 207 are all connected to the built-in computer 206, controlled by the built-in computer 206, and arranged in the housing 201. The wireless communication device 207 is operatively connected to the central control system 108 of the four-wheel drive 3 and configured to control the four-wheel drive 30 to do automatic pathfinding. The wireless communication device 207 can also be connected to an external computer to transmit information in real time through supporting software. The battery compartment 208 is disposed in the housing 201, and the lithium battery 4 is secured in the battery compartment 208. The electronic screen 205 is arranged at a rear side of the housing 201 and connected to the built-in computer 206. The range finder 209 is secured on the top of the housing 201. The incline compensator 210 is secured at the bottom of the housing 201. The range finder 209 and the incline compensator 210 may eliminate a need of manual leveling for the blasting design instrument body 1 in use.

As illustrated in FIG. 6, the 3D laser scanning device 202 mainly includes laser radars 301, speed sensors 302, a filter lens 303, motors 304, panoramic cameras 305, time counters 306, and central processors 307. The laser radars 301, the speed sensors 302, the motors 304, the panoramic cameras 305, the time counters 306 and the central processors 307 are divided into two groups and arranged on left and right sides of the filter lens 303 symmetrically. The filter lens 303 is connected with the motors 304, and driven to rotate by the motors 304 located on two sides thereof to control motion directions of laser lights emitted from the laser radar 301 to be vertical, thereby performing a vertical scanning of a to-be-measured object. The speed sensor 302 is connected with the motor 304 and configured to record rotation parameter information.

The panoramic camera 305 is configured to record a holographic image and a corresponding panoramic point cloud image according to a central projection principle, and establish corresponding control points on the holographic image and the point cloud image of 3D laser scanning. The time counter 306 is configured to record time information. The laser radars 301, the speed sensors 302, the filter lens 303, the motors 304, the panoramic cameras 305 and the time counters 306 are controlled by the respective central processors 307 and arranged in the housing 201. The central processors 307 are connected to the built-in computer 206. The central processors 307 and the laser radars 301 internally include laser emitters, antennas, receivers and tracking mounts. A wavelength of each the laser emitter is 1550 nanometers (nm), a beam divergence angle of each the laser emitter is 0.3 milliradians (mrad), and an output beam of each the laser emitter is 2.12 nm.

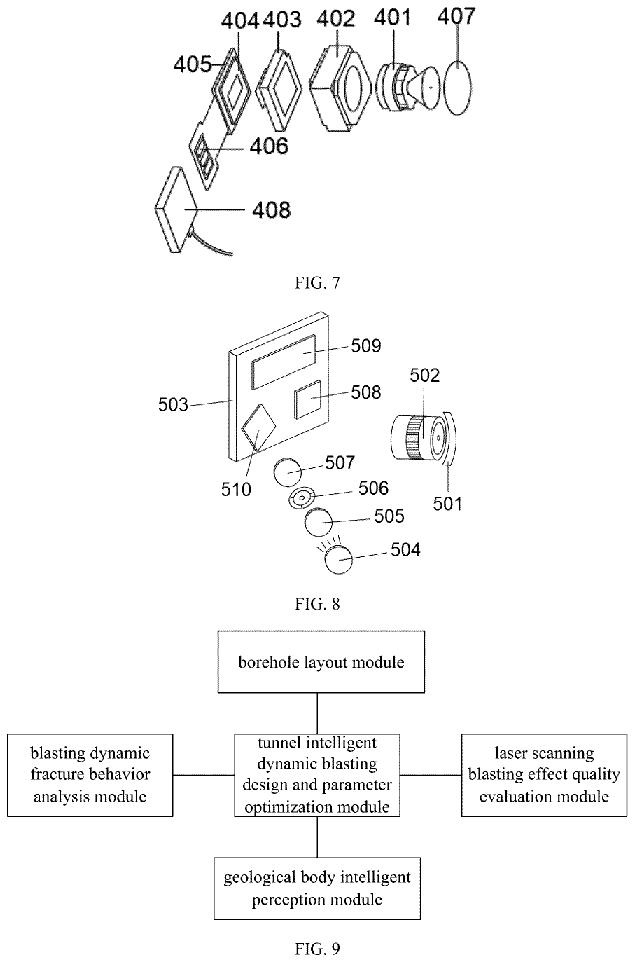

As illustrated in FIG. 7, the digital camera device 203 mainly includes a lens 401, a VCM motor 402, a base 403, an IR filter 404, an image sensor 405, a PCB circuit board 406, and a main processor 408. The lens 401 is responsible for imaging and focusing. A protective glass 407 is arranged in front of the lens 401. The VCM motor 402 is arranged behind the lens 401, an image distance of the lens 401 is changeable, and an automatic focusing of the lens 401 can be realized through infrared distance measurement. The base 403 is arranged behind the VCM motor 402, and is responsible for fixing the lens 401 and the VCM motor 402. The IR filter 404 is arranged behind the base 403, and serves as a filter for filtering infrared light. The image sensor 405 is arranged behind the IR filter 404, and is a photosensitive component of CCD that can convert an image into an electrical signal. The PCB board 406 is arranged behind the image sensor 405 and is responsible for power supply control and signal transmission, and receives the electrical signal generated by the image sensor 405 and then transmits to the main processor 408. The main processor 408 is connected to the built-in computer 206.

As illustrated in FIG. 8, the borehole locating device 204 mainly includes a dustproof cover 501, a projection lens 502, a DLP circuit board 503, a projection light source 504, a convergence lens 505, a color wheel 506, and a correction lens 507. The dustproof cover 501 is arranged on the forefront of the borehole locating device 204 and plays a role of dustproof protection. The projection lens 502 is arranged behind the dustproof cover 501 and is covered by the dustproof cover 501. A lower part of the dustproof cover 501 is connected with the housing 201. The projection lens 502 is configured to project an image onto a tunnel face (also referred to as working face) and can automatically adjust a projection angle according to a distance from the tunnel face.

The DLP circuit board 503 is provided with three important electronic components respectively being a memory 508, an image controller 509 and a DMD chip 510. The memory 508 is configured to store image information of boreholes. The image controller 509 is configured to transmit an image of boreholes to the DMD chip 510 according to the image information stored in the memory 508 and performs structure control of the lens. The DMD chip 510 is configured to control turn-on and deflection of mirrors to achieve the purpose of image display. The projection light source 504 is an LED lamp. The convergence lens 505 is arranged in front of the projection light source 504, and can converge parallel light rays of the projection light source 504 onto the color wheel 506. The color wheel 506 is arranged in front of the convergence lens 505. A color of the color wheel 506 is red, so that the light rays are converted into red color. The correction lens 507 is arranged in front of the color wheel 506 and can shape light passing through the color wheel 506 so that the light strikes on the DMD chip 510.

When conducting an excavation work of a tunnel, firstly, the four-wheel drive 3 and the blasting design instrument body 1 are simultaneously opened, coordinates of a fixed point required by the whole equipment are input, and the whole equipment is placed on a center line of the tunnel, so that the digital camera device 203 and the borehole locating device 204 rightly face towards an excavation cross-section and are roughly leveled, and the interior of the blasting design instrument body 1 can carry out automatic leveling based on data of the range finer 209 and the incline compensator 210. After the four-wheel drive 3 finds an initial position, the 3D laser scanning device 202 and the digital camera device 203 are used to scan and photograph the tunnel face. After a design is completed, the operation is switched to the borehole locating device 204, and positions of boreholes are marked by a worker after laser beams for borehole locating are stable. Operations of drilling boreholes and explosives-charging the boreholes subsequently are performed, and then detonation is carried out after the operations of drilling and explosives-charging are completed. After the tunnel face is blasted and slagged, the blasting design instrument body 1 is used again and a new coordinate point is input, and after an automatic pathfinding is completed, the 3D laser scanning device 202 is used to identify over-excavation and under-excavation conditions after blasting to obtain tunnel blasting quality evaluation information. The information is automatically stored to the built-in computer 206, and a tunnel intelligent dynamic blasting design and parameter optimization module optimizes tunnel blasting design parameters. After the optimization is completed, a new round of blasting design can be carried out; and after the completion of using the whole equipment, the tunnel blasting design instrument body 1 and the four-wheel drive 3 are closed.

### Embodiment 2

As illustrated in FIG. 9, in another aspect, the invention provides a design system for tunnel dynamic blasting. The design system is installed in the built-in computer 206, and can be installed in an external computer through software instead. The design system mainly includes a geological body intelligent perception module (for surrounding rock image recognition and intelligent grading, fracture quantitative identification, and tracking of tunnel blasting fracture), a tunnel intelligent dynamic blasting design and parameter optimization module (for parameter design and parameter optimization), a blasting dynamic fracture behavior analysis module, a laser scanning blasting effect quality evaluation module, and a borehole layout module. The tunnel intelligent dynamic blasting design and parameter optimization module is connected to the geological body intelligent perception module, the blasting dynamic fracture behavior analysis module, the laser scanning blasting effect quality evaluation module and the borehole layout module, individually. Specifically, the geological body intelligent perception module can receive point cloud data obtained by the 3D laser scanning device 202 and image data obtained by the digital camera device, and transmit generated surrounding rock information such as a grade and joint fractures to the tunnel intelligent dynamic blasting design and parameter optimization module for blasting design. The tunnel intelligent dynamic blasting design and parameter optimization module can design blasting parameters according to obtained surrounding rock information, and can also optimize the blasting parameters according to quality evaluation information and numerical simulation results. The borehole layout module can receive information of the designed blasting parameters from the tunnel intelligent dynamic blasting design and parameter optimization module to draw a borehole layout, and can transmit information of the borehole layout to the borehole locating device.

The blasting dynamic fracture behavior analysis module can carry out numerical simulation according to the designed blasting parameters and the borehole layout, determine feasibility of a scheme, and transmit the information of the borehole layout to the borehole locating device if the scheme is determined as passed, or transmit the information back to the tunnel intelligent dynamic blasting design and parameter optimization module for parameter optimization if the scheme is determined as not passed. The laser scanning blasting effect quality evaluation module can receive data from the 3D laser scanning device and the digital camera device and analyze over-excavation and under-excavation conditions after tunnel blasting. The modules of the design system complete a resultant design work by information coordination. In an exemplary embodiment, the geological body intelligent perception module, the tunnel intelligent dynamic blasting design and parameter optimization module, the blasting dynamic fracture behavior analysis module, the laser scanning blasting effect quality evaluation module, and the borehole layout module are software modules stored in one or more memories and executable by one or more processors coupled to the one or more memories.

The geological body intelligent perception module is configured to identify a surrounding rock mass, mainly identify a type of the surrounding rock mass, whether the surrounding rock mass is homogeneous or not, a structural plane of the surrounding rock mass, and so on. The geological body intelligent perception module includes three functions that surrounding rock image recognition and intelligent grading, fracture quantitative identification, and tracking of tunnel blasting fracture condition. The surrounding rock image recognition and automatic grading can identify the surrounding rock mass of the tunnel face and judge the grade of the surrounding rock mass, through the digital camera device 203. The fracture quantitative identification is carried out by analyzing a point cloud image generated by scanning of the 3D laser scanning device 202, identifying fractures of the surrounding rock mass of the tunnel face and marking. The tracking of tunnel blasting fracture condition is carried out in software, and the function can be used to track the tunnel blasting fracture condition and thereby obtain a fracture boundary. The type of the surrounding rock mass can be obtained by identifying a type of the surrounding rock mass of the tunnel face according to the image captured by the digital camera device 203, then lithologic information of the surrounding rock mass is acquired by comparing the obtained type of the surrounding rock mass with various rock mass types in a database, and appropriate explosives are matched according to the lithologic information. In particular, a characteristic impedance of explosives (i.e., a product of a density and an explosion velocity of the explosives) should be matched with a characteristic impedance of rock mass (i.e., a product of a density of the rock and a propagation velocity of longitudinal wave in the rock). In order to improve the blasting effect, the type of explosives must be selected according to the characteristic impedance of rock mass, so that the characteristic impedances of the explosives and the rock mass can be matched with each other. The homogeneity of rock mass can be determined by the image recognition technology and an inhomogeneous rock mass can be divided into regions directly. Whether the rock mass is homogeneous or not has a great different influence on the blasting effect. For a homogeneous rock mass, some factors such as physical and mechanical properties of rock and blastability of the rock mass should be considered comprehensively. For an inhomogeneous rock mass, due to different mechanical properties in the rock mass, the blasting is easy to break through from soft parts and thus affects the blasting effect; and thus generally speaking, it has a negative impact on the blasting effect and the blasting consequence. The impact on the blasting effect is mainly to change the direction of minimum resistance line, causing a blasting force and a throwing distance not to meet design requirements. The impact on the blasting consequence is mainly due to the fact that the explosion energy is concentrated in the loose directions with small resistance, which enlarges the scope that should not be destroyed, and moreover, some flying rocks may be thrown far away, causing harm. For the inhomogeneous rock mass, the design system uses the form of multiple explosives packages, which can well prevent the explosion energy from concentrating on a weak rock mass or a weak structural plane. The structural plane of rock mass has a great influence on the blasting effect, and the degree of influence depends on a nature of the structural plane and a relationship between its occurrence and a position of explosives package. However, there are many kinds of structural planes in the rock mass in practical engineering, so the relationship among them must be considered comprehensively, and a structural plane playing a leading role among them must be found out. The geological body intelligent perception module firstly recognizes a tunnel face image through the digital camera device 203, comparatively analyzes the recognized image with pictures in a surrounding rock database, and finally determines a grade of surrounding rock mass; then, identifies changes in the surrounding rock mass through a point cloud image obtained by scanning of the 3D laser scanning device 202, extracts edge features of the tunnel face to generate an excavation contour graph, identifies and marks fractures in the excavation contour graph, and transmits the contour graph to a projection device; further identifies the type of a surrounding rock mass in the identified excavation contour graph; afterwards, identifies joints and fractures of the surrounding rock mass of the tunnel face and finally gives the grade of the surrounding rock mass by combining weighting values of the two identified contents, and then transmits surrounding rock information to the tunnel intelligent dynamic blasting design and parameter optimization module.

The tunnel intelligent dynamic blasting design and parameter optimization module is configured to design tunnel blasting parameters and optimize the designed blasting parameters according to an evaluation result of the laser scanning blasting effect quality evaluation module. The tunnel intelligent dynamic blasting design and parameter optimization module can receive the result obtained by the geological body intelligent perception module, and then can design the tunnel blasting parameters after being input with some parameters selected manually, and further can optimize the designed blasting parameters according to the evaluation result of the laser scanning blasting effect quality evaluation module, so as to improve the blasting quality. A principle is that: the tunnel intelligent dynamic blasting design and parameter optimization module firstly selects corresponding blasting design parameter influence values according to the grade of surrounding rock mass obtained by a surrounding rock image recognition and automatic grading module, then substitutes the influence values into a blasting design parameter calculation formula to automatically obtain the tunnel blasting design parameters, and then transmits the tunnel blasting design parameters to the borehole layout module. The parameter optimization is that: different adjustments are made for different problems of blasting quality according to a set optimization algorithm. For example, when a blasting footage is not satisfied, such as the tunnel face is uneven, resulting in a footage in the cut area is large, a row number of reliever-hole should be increased so as to reduce the length of minimum resistance line; if the tunnel face is relatively flat, it is necessary to increase a density of cut-holes, and then if it is still not satisfied, it is necessary to use two-stage or three-stage cutting until the design footage is reached. In case of under-excavation, it is necessary to reduce a spacing among perimeter-holes and a thickness of smooth blasting layer, and increase the number of boreholes and charges of boreholes. In case of over-excavation, it is necessary to increase the spacing among perimeter-holes and the thickness of smooth blasting layer, and reduce the number of boreholes and the charges of boreholes. Afterwards, a blasting design scheme is regenerated according to adjusted blasting parameters (also referred to as blasting design parameters).

The blasting dynamic fracture behavior analysis module is configured to carry out numerical simulation based on the blasting parameters designed by the tunnel intelligent dynamic blasting design and parameter optimization module and the borehole layout generated by the borehole layout module, to preliminarily test rationality of the blasting parameters and the borehole layout. The blasting dynamic fracture behavior analysis module is realized by using a peridynamic (PD) simulation method, identifies a fracture of the surrounding rock mass of the tunnel face before and after blasting, performs numerical simulation on a fracture form of the surrounding rock mass in the blasting process according to a change of the fracture, analyzes a fracture behavior of the surrounding rock mass under the action of blasting in the numerical simulation process to determine whether the blasting parameters and the borehole layout are reasonable or not. Through this method, the blasting parameters and the borehole layout can be optimized for adjustment.

The laser scanning blasting effect quality evaluation module is configured to perform noise reduction and analysis on the point cloud data obtained by the 3D laser scanning device in operation to obtain a tunnel blasting excavation result, and score. A principle is that: firstly, reading point cloud data obtained by the 3D laser scanning device 202 in operation, performing a noise reduction operation on the point cloud data to remove discontinuous noise points, then reconstructing the noise-reduced point cloud data to obtain a point cloud image, generating a tunnel contour graph in the point cloud image, comparing the point cloud image with the tunnel contour graph for analysis to obtain conditions of tunnel over-excavation and under-excavation, blasting footage, flatness and the like, evaluating the current round of blasting, and transmitting the evaluation result to a tunnel intelligent dynamic blasting design and parameter optimization module.

The borehole layout module is configured to automatically generate a borehole layout according to the fracture of the tunnel face and the blasting parameters designed by the tunnel intelligent dynamic blasting design and parameter optimization module, and transmit the generated borehole layout to a projection device. A principle is that: firstly, determining borehole layout parameters such as the number of boreholes, the minimum resistance line and the row spacing according to the blasting parameters given by the tunnel intelligent dynamic blasting design and parameter optimization module, then selecting an arrangement form of cut-holes according to the condition of the fracture of the tunnel face, and finally obtaining the borehole layout for a tunnel.

### Embodiment 3

In order to realize a parametric design of boreholes and explosives-charging and an automatic generation of blasting scheme in tunnel excavation by a drilling-blasting method, \textcircled{1} introducing geometric parameters of a tunnel, which include size and shape of a cross section, and determining a grade of a surrounding rock mass, an excavation method, a cyclic footage and the like according to conditions of the surrounding rock mass; \textcircled{2} determining a borehole diameter according to construction conditions, and realizing a design of borehole parameters by compiling a borehole parameter generation method and a desktop interactive design; \textcircled{3} selecting a type of explosives, generating explosives-charging parameters through an empirical formula according to engineering geological conditions and rock mass volume undertaken by blasting, and configuring charges of boreholes and explosives-charging structures of boreholes to realize explosives-charging parameter design; \textcircled{4} through compiling a generation process of blasting design scheme, realizing the automatic generation of the blasting scheme according to the above design steps.

As illustrated in FIG. 11, the invention provides a blasting method of a tunnel dynamic blasting device based on geological body intelligent perception, including steps as follows.

Step 1, obtaining position information of a tunnel face through the blasting design instrument body 1, and transmitting the information to the built-in computer 206.

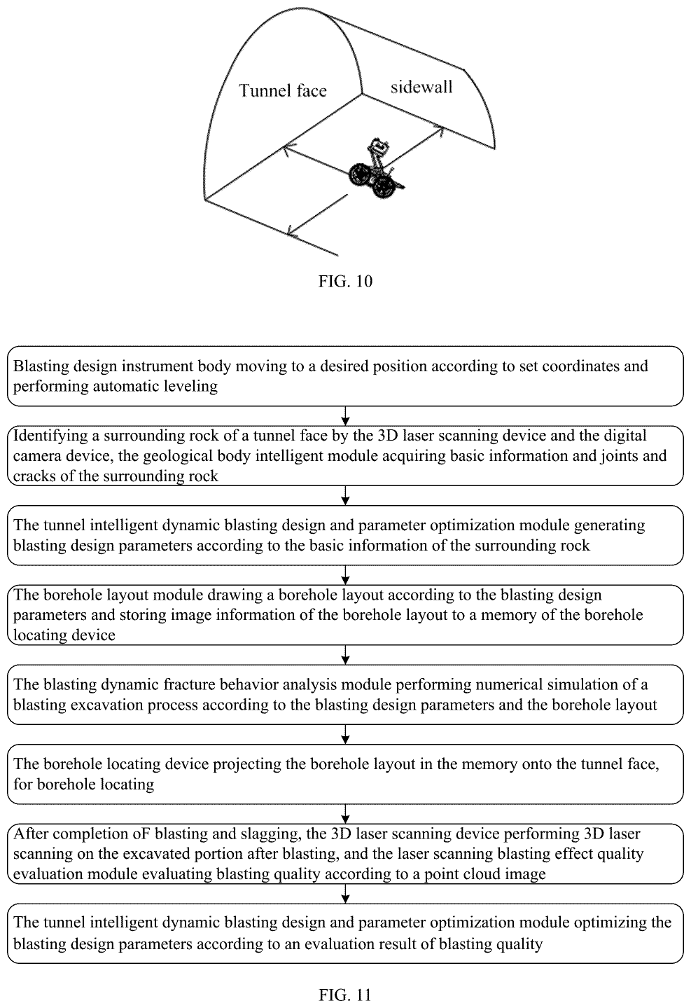

Specifically, the blasting design instrument body 1 is placed near a tunnel face, as shown in FIG. 10, after the whole equipment is powered on, location point coordinates of the equipment are manually input on the blasting design instrument body 1, after the input is completed, the four-wheel drive 3 will do automatic pathfinding. A working principle of the automatic pathfinding is that a Cartesian coordinate system is established with a center of the blasting design instrument body 1 as the origin, the range finder 209 in the blasting design instrument body 1 will measure a distance between the equipment (e.g., including the blasting design instrument body 1 and the four-wheel drive 3) and the tunnel face, a distance between the equipment and a top rock mass, and distances from the equipment to the rock masses on both sides, the current position (i.e., the position information) of the equipment is determined according to the four distances, and then the position information is transmitted to the built-in computer 206. The built-in computer 206 then issues a motion command for four-wheel drive 3 based on a relationship of the position coordinates with the input coordinates.

Step 2, performing 3D laser scanning on the tunnel face to generate a point cloud image of a vicinity of the tunnel face and transmitting information data of the point cloud image to the built-in computer 206, by the 3D laser scanning device 202; acquiring edge features of the tunnel face, locking/determining an identified region as a region of the tunnel face, identifying a type of a surrounding rock mass and joints and fractures of the surrounding rock mass of the tunnel face and transmitting identified information to the built-in computer 206, by the digital camera device 203; and performing multi-view three-dimensional reconstruction on the obtained point cloud data and inputting reconstructed surrounding rock information to the tunnel intelligent dynamic blasting design and parameter optimization module, by the geological body intelligent perception module in the built-in computer 206.

Specifically, the digital camera device 203 recognizes an image of the tunnel face through a camera, mainly identifies a change of the surrounding rock mass, extracts the edge features of the tunnel face to generate an excavation contour graph, transmits the contour graph to a projector of the borehole locating device 204, and further identifies the type of the surrounding rock mass in the identified excavation contour graph, then identifies the joints and the fractures of the surrounding rock mass of the tunnel face, and transmitting identified result information to the geological body intelligent perception module in the built-in computer 206 through the PCB circuit board 406.

The geological body intelligent perception module performs the multi-view three-dimensional reconstruction on the obtained point cloud data. In the reconstruction processing, intrinsic and extrinsic parameters of the camera can be estimated according to features, and thereby conversion from two-dimensional coordinates of a camera image to three-dimensional coordinates in a world coordinate system is completed.

$${p}_{img} = {KP}_{c} ; {P}_{c} = {RP}_{w} + t ,$$

where, P_{img} represents pixel coordinates of a pixel in the image; K represents an intrinsic parameter matrix of the camera; P_{c} represents 3D point coordinates in a camera coordinate system; P_{w} represents coordinates in the world coordinate system, and a rotation matrix R and a translation vector t can be used to transform P_{c} to P_{w}.

Step 3, selecting corresponding blasting design parameter influence values according to the obtained surrounding rock information, substituting the influence values into a blasting design parameter formula to obtain tunnel blasting design parameters and then transmitting the tunnel blasting design parameters to the borehole layout module, by the tunnel intelligent dynamic blasting design and parameter optimization module in the built-in computer 206.

The blasting design parameters are mainly used for calculations of borehole parameters and charges. The borehole parameters mainly include a borehole diameter, depths of boreholes, number of boreholes, spacings of boreholes, design (e.g., structural design) of boreholes, and layout of boreholes. The calculations of charges include powder factor, quantity of explosives required for one excavation cycle, and charges of various blastholes, as well as safety checks.

(1) borehole diameter d. Comprehensive analysis should be conducted based on a size of cross-section, a requirement of fragmentation, a capacity of rock drilling equipment and performance of explosives. In an illustrated embodiment, the borehole diameter is determined based on a cartridge diameter and standard drill bit diameters of the YT28 type rock drill and a three-arm rock drill jumbo.

(2) depths of boreholes L. A cut-hole depth is deeper than a bottom of perimeter-hole with 100˜ 200 mm. When an inclined cut is employed, the cut-hole depth is directly related to a perimeter-hole depth and an intersection angle between a cut-hole and an excavation face, and a calculation formula is as follows:

$${L}_{ch} = \frac{{L}_{0} / η + 0.2}{sin θ} ;$$

where, L₀ represents a tunnel excavation cyclic footage, with a unit of meter (m); L_{ch} represents the cut-hole depth, with a unit of m; and θ represents the intersection angle between the cut-hole and the excavation face, with a unit of degree (°).

A calculation formula of the perimeter-hole depth is as follows:

$${L}_{ph} = \frac{{L}_{0}}{η \times cos α} ;$$

where, Lₚₕ represents the perimeter-hole depth, with a unit of m; L₀ represents the tunnel excavation cyclic footage, with the unit of m; η represents an efficiency of borehole, with a value in a range of 0.85˜0.95, and the value generally is 0.9; a represents an extrapolation angle of perimeter-hole, with a unit of ° and a value generally in a range of 3° ˜5°.

A calculation formula of a reliever-hole depth is as follows:

$${L}_{rh} = \frac{{L}_{0}}{η} ;$$

where, Lᵣₕ represents the reliever-hole depth, with a unit of m; L₀ represents the tunnel excavation cyclic footage, with the unit of m; η represents the efficiency of borehole, with the value generally is 0.9.
(3) number of boreholes N. Factors affecting the number of boreholes mainly are an area of tunnel cross-section, lithological properties, the borehole diameter, the depths of boreholes, the performance of explosives, and so on. On the premise of meeting the blasting effect, the number of boreholes shall be reduced as much as possible. Cut-holes shall be arranged first, then perimeter-holes are arranged, and finally reliever-holes are arranged.

Firstly, the number of boreholes is estimated as follows:

$$N = 3.3 \sqrt[3]{{fS}^{2}} ;$$

where, Nrepresents the number of boreholes, and its calculation result is rounded to be an integer; ƒ represents a firmness coefficient of rock, i.e., Protodyakonov's coefficient, and ƒ=R_{c}/10, R_{c} represents a uniaxial saturated compressive strength of rock with a unit of megapascal (Mpa), and R_{c} can be obtained through a design drawing or an on-site test; S represents the area of tunnel cross-section, with a unit of m².
(4) spacings of boreholes. For cut-holes, a vertical hole spacing a is generally 0.6˜1.0 m, a row spacing b=2×(Lₚₕ+0.2)/tanθ+0.2, generally is 0.6˜0.8 m, and a row spacing of hole openings of the most central left and right cut-holes is 1.2˜2.0 m. For reliever-holes: a hole spacing is generally 0.6˜1.0 m, and a row spacing is 0.6˜0.9 m.

For perimeter-holes: the hole spacing generally is 0.3˜0.6 m.
(5) powder factor (also referred to as unit explosives consumption) k.

$$k = 1.1 {k}_{0} \sqrt{\frac{f}{S}} ;$$

where, k represents the powder factor, with a unit of kg/m³; k₀ represents an explosives power correction coefficient, k₀=525/P, and P represents a selected explosives power (also referred to as explosion power of selected explosives), with a unit of milliliter (mL); ƒ represents the firmness coefficient of rock, i.e., Protodyakonov's coefficient; S represents the area of tunnel cross-section, with the unit of m².
(6) quantity of explosives required for one excavation cycle Q. For the excavation face, the quantity of explosives required for one excavation cycle Q is calculated as per a formula as follows:

Q=kSLη;
where, k represents the powder factor, with the unit of kg/m³; S represents the area of tunnel cross-section, with the unit of m²; L represents the depths of boreholes, with the unit of m; η represents the efficiency of borehole, with a value in a range of 0.85˜0.95, and the value generally is 0.9.
(7) single-hole charge. Based on on-site experiences, it is relatively accurate to calculate a single cut-hole charge according to a borehole charge coefficient and a weight per meter of explosives cartridge, and an uncoupled continuous charge structure is used for explosives-charging.

Q_{schc}=rnL_{ch};
where, Q_{schc} represents a single cut-hole charge, with a unit of kilogram (kg); r represents a weight of a cartridge with a length of 1 meter, calculated as per cartridge specification of selected explosives, with a unit of kg/m; n represents the borehole charge coefficient, with a value generally in a range of 0.5˜0.8, actually taken as the maximum value of 0.8; L_{ch} represents the cut-hole depth, with the unit of m.

A single perimeter-hole charge is mostly calculated using a line charge density, and an uncoupled air-spaced charge structure is generally used for explosives-charging.

Q_{sphc}=qₓLₚₕ;
where, Q_{sphc} represents the single perimeter-hole charge, with a unit of kg; qₓ represents the line charge density of perimeter-hole, with a unit of kg/m, and a value thereof is in a range of 0.15˜0.25 kg/m; Lₚₕ represents the perimeter-hole depth, with the unit of m.

A single reliever-hole charge is generally calculated according to a volume method, and an uncoupled continuous charge structure is used for explosives-charging.

Q_{srhc}=kabLᵣₕ;
where, Q_{srhc} represents the single reliever-hole charge, with a unit of kg; a represents a hole spacing of reliever-holes, with a unit of m, and a value thereof is in a range of 0.6˜1.0 m; b represents a row spacing of reliever-holes, with a unit of m, and a value thereof is in a range of 0.6˜0.9 m; Lᵣₕ represents the reliever-hole depth, with a unit of m.

Step 4, obtaining a borehole layout of the tunnel according to the blasting design parameters and transmitting image information of the borehole layout to the memory 508 in the borehole locating device 204, by the borehole layout module in the built-in computer 206.

Specifically, the borehole layout module in the built-in computer 206 determines borehole layout parameters such as the number of boreholes, a minimum resistance line and the row spacings according to given blasting design parameters, then optimizes an arrangement form of the cut-holes according to a fracture condition of the tunnel face to finally obtain the borehole layout of the tunnel, and transmits the image information to the memory 508 in the borehole locating device.

Step 5, performing numerical simulation of a blasting process according to the blasting design parameters obtained by the tunnel intelligent dynamic blasting design and parameter optimization module and the borehole layout generated by the borehole layout module, and analyzing whether explosives-charging parameters and the borehole layout whether are reasonable by analyzing fracture behavior of the surrounding rock mass under the action of blasting in the process of numerical simulation, by the blasting dynamic fracture behavior analysis module in the built-in computer 206. Through this method, the explosives-charging parameters and the borehole layout can be optimized for adjustment.

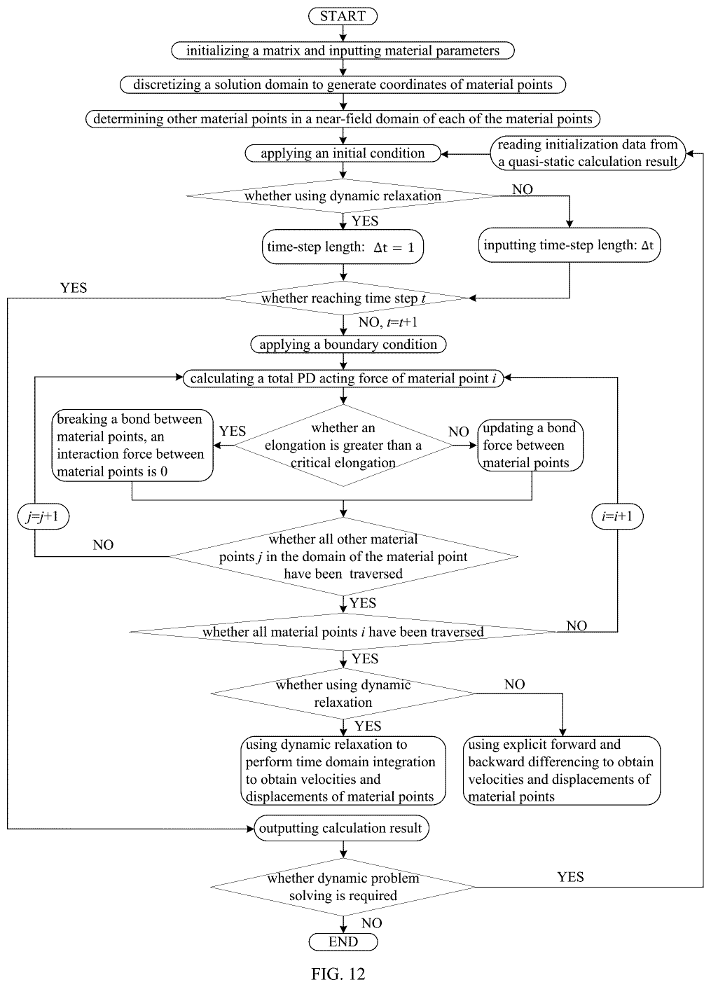

As illustrated in FIG. 12, a method of numerical simulation is as follows.
a) Initializing a virtual diagonal density matrix, and determining input material parameters according to lithological parameters of a surrounding rock mass obtained by the geological body intelligent perception module;
b) discretizing a solution domain to generate coordinates of material points; specifically, uniformly discretizing a macroscopic continuum into a finite number of material points each with a size of Ax, and transforming a spatial integral equation into a solution of a finite sum;
c) determining other material points in a near-field domain of each of the material points, namely, all other material points within a radius of the near-field domain of each the material point;
d) applying an initial condition, judging whether using dynamic relaxation or not, if using the dynamic relaxation, setting a time-step length Δt=1, if not using the dynamic relaxation, setting the time-step length Δt as needed; judging whether calculation is finished or not by judging whether a time step t is reached or not, outputting a calculation result if the time step t is reached, otherwise, applying a boundary condition, and keeping current state to carry out a simulation process of next time step and calculate a total PD acting force of the material point i;
e) when an elongation is greater than a critical elongation, breaking a bond between material points so that an interaction force between the material points is zero; otherwise, updating a bond force between the material points;
f) judging whether all the other material points j in the domain of the material point have been traversed, if yes, judging whether all the material points i have been traversed, and then judging whether using dynamic relaxation after all the material points i have been traversed, if yes, using the dynamic relaxation to carry out time domain integration to thereby obtain velocities and displacements of the material points; otherwise, using explicit forward and backward differencing to obtain velocities and displacements of the material points.

In an illustrated embodiment, the numerical simulation uses a dynamic relaxation method in peridynamics (also referred to as near-field dynamics), manually introduce damping into a system to consume kinetic energy of the system, so that the system quickly enters a stable state, thereby obtaining a steady-state solution. In order to select an appropriate damping coefficient and accelerate the convergence rate, an adaptive dynamic relaxation (ADR) method is used to determine a damping coefficient per unit time in the process of rock blasting damage.

According to the ADR method, virtual inertia and local damping are introduced to all material points in the system, and an equation for solving a static problem in PD is obtained as follows:

$$Λ \ddot{u} = c Λ \dot{u} + L = b ;$$

where, Λ represents the virtual diagonal density matrix, μ represents a displacement, c represents a damping coefficient, L represents a volume force density of PD interaction force and L=Σ_{H}^{k}ƒ(ηⁿ, ζ)V_{x′}, b represents a volume force density of external force.

Velocities and displacements at different time steps can be obtained by a central difference method as follows:

$${\dot{u}}^{1 / 2} = \frac{Δ t {Λ}^{- 1} ( {b}^{0} - {L}^{0} )}{2} ( n = 0 )$$

$${\dot{u}}^{n + 1 / 2} = \frac{( 2 - {c}^{n} Δ t )}{2 + {c}^{n} Δ t} {\dot{u}}^{n - 1 / 2} + \frac{2 Δ t {Λ}^{- 1} ( {b}^{n} - {L}^{n} )}{2 + {c}^{n} Δ t}$$

$${u}^{n + 1} = {u}^{n} + Δ t {\dot{u}}^{n + 1 / 2} ;$$

Where, Δt represents a time-step length.

To obtain the velocities and displacements at different time steps, it is needed to know the density matrix Λ, the damping coefficient c and the time-step length Δt. Relevant literature studies show that these three values do not affect a final result of the steady-state solution. Appropriate parameters should be selected based on the principle of ensuring the algorithm to be converged with a minimum time step. In the dynamic relaxation method, a commonly used time-step length Δt=1.

The virtual diagonal density matrix Λis selected according to the Greschgorin theorem:

$${λ}_{ii} \geq \frac{Δ {t}^{2}}{4} {\sum }_{j = 1}^{n} \vert {K}_{ij} \vert$$

where, λᵢᵢ represents diagonal elements of the virtual diagonal density matrix Λ; Kᵢⱼ represents a stiffness matrix, and is expressed by a partial derivative of the PD interaction force between material points with respect to a relative displacement:

$${\sum }_{j = 1}^{n} \vert {K}_{ij} \vert = {\sum }_{j = 1} \vert \frac{\partial f ( ξ , η ) {V}_{j}}{\partial η} \vert .$$

For the damping coefficient c, an effective damping at each time step can be calculated to solve the steady-state solution using the formula as follows:

cⁿ=
where, Kⁿ represents a diagonal local stiffness matrix,

$${K}_{ii}^{n} = - ( {L}_{i}^{n} / {λ}_{ii} - {L}_{i}^{n - 1} / {λ}_{ii} ) / ( Δ t {\dot{u}}_{i}^{n - \frac{1}{2}} ) .$$

Finally, according to the damping coefficient of each step, influence of a relative position relationship between explosives and a borehole in a blasting process on a development process of rock mass fractures in the blasting process can be obtained, that is, whether a development trend of main fracture/crack in each step is to develop towards a neighboring borehole outside a contour line on which the borehole is located, and this kind of borehole is called as the reasonable borehole. With the increase of spacings of boreholes, cracks generated between the boreholes cannot be connected; under a hydrostatic geostress level, with the increase of geostress, crack propagation time decreases and damage initiation time lags behind; and under a non-hydrostatic geostress level, blasting-induced crack tends to propagate in a direction of maximum principal stress, and with the increase of a lateral pressure coefficient, a damage area decreases, and directionality of crack propagation is more obvious. The geostress inhibits blasting cracking of rock, while the non-hydrostatic geostress level can guide the crack propagation. In an actual blasting excavation process, selecting appropriate borehole spacings and arranging the boreholes along the direction of maximum principal stress, which are conducive to forming a good blasting excavation face and improving the efficiency of rock breaking. According to the above analysis, there is a reasonable range for the explosives-charging parameters and the borehole layout, and final explosives-charging parameters and borehole layout can be in the reasonable range through continuous numerical simulation, and a judgment criterion of the reasonable range is that the number of reasonable boreholes accounts for 80%˜100%.

Step 6, generating a borehole layout image based on the borehole layout information in the memory 508 by the image controller 509 in the borehole locating device 204, and projecting positions of all boreholes (including cut-holes, perimeter-holes and reliever-holes) on the tunnel face.

Specifically, the image controller 509 in the borehole locating device 204 generates the borehole layout image according to the borehole layout information in the memory 508 and then generates a picture on the DMD chip 510, and then adjusts a projection angle of the projection lens 502 according to the distance between the blasting design instrument body 1 and the tunnel face so that positions of the perimeter-holes fall on an excavation contour line. Then, the DMD chip 510 controls turn-on and deflection of mirrors, so as to project all borehole positions on the tunnel face.

Step 7, after completion of tunnel blasting and slagging, performing three-dimensional laser scanning on the blasted tunnel face to obtain a three-dimensional point cloud image after the blasting and transmitting the image to the laser scanning blasting effect quality evaluation module in the built-in computer 206, by the 3D laser scanning device 202; and analyzing the point cloud image to obtain the tunnel blasting quality result and then transmitting the tunnel blasting quality result to the tunnel intelligent dynamic blasting design and parameter optimization module for parameter optimization, by the laser scanning blasting effect quality evaluation module.

Specifically, the motors 304 drive the filter lens 303 to rotate so as to control laser beams emitted by the laser radars 301 to move in a vertical direction and vertically scan an object to be measured, and moreover the motors 304 drive the tunnel blasting design instrument body 1 to rotate in a horizontal plane, and the speed sensors 302 are connected with the respective motors 304 and records rotation parameter information thereof. Under the co-action of the two motors 304, the 3D laser scanning device 202 in the blasting design instrument body 1 can realize 3600 scanning of surrounding objects. The filter lens 303 can expand light emitted by the laser radar 301 into a light strip in one direction, and then project the light strip to an object surface. Due to a change of curvature or depth of the object surface, the light strip is deformed, and then the panoramic camera 305 captures a pattern of the deformed light strip. In this way, according to an emission angle of laser beam and an imaging position of laser beam in the panoramic camera 305, a distance or position data of the measured point can be obtained through a triangular geometric relationship. The panoramic camera 305 can convert a panoramic image into a panoramic spherical point cloud according to a central projection imaging principle, by establishing corresponding control points on the panoramic image and the point cloud obtained by 3D laser scanning, and by recording three-dimensional coordinates, reflectivity, texture and other information of a large number of dense points on the surface of the measured object, data of a three-dimensional model and various graphic components such as line, surface and body of the measured object can be quickly reconstructed. Finally, after being processed by the central processors 307, these data will be directly transmitted to the built-in computer 206. The laser scanning blasting effect quality evaluation module of the built-in computer 206 will analyze image data of point cloud to obtain the tunnel blasting quality evaluation information, and then transmit the blasting quality evaluation information to the tunnel intelligent dynamic blasting design and parameter optimization module.

In addition, the interior of the blasting design instrument body 1 further includes a wireless communication device 207. The wireless communication device 207 (e.g., WiFi module or Bluetooth module) communicates with an external computer through a wireless network, the external computer must be installed with matching software, and the software can view information of various stages in the whole working process of the blasting design instrument body 1.

### Simulation Experiment

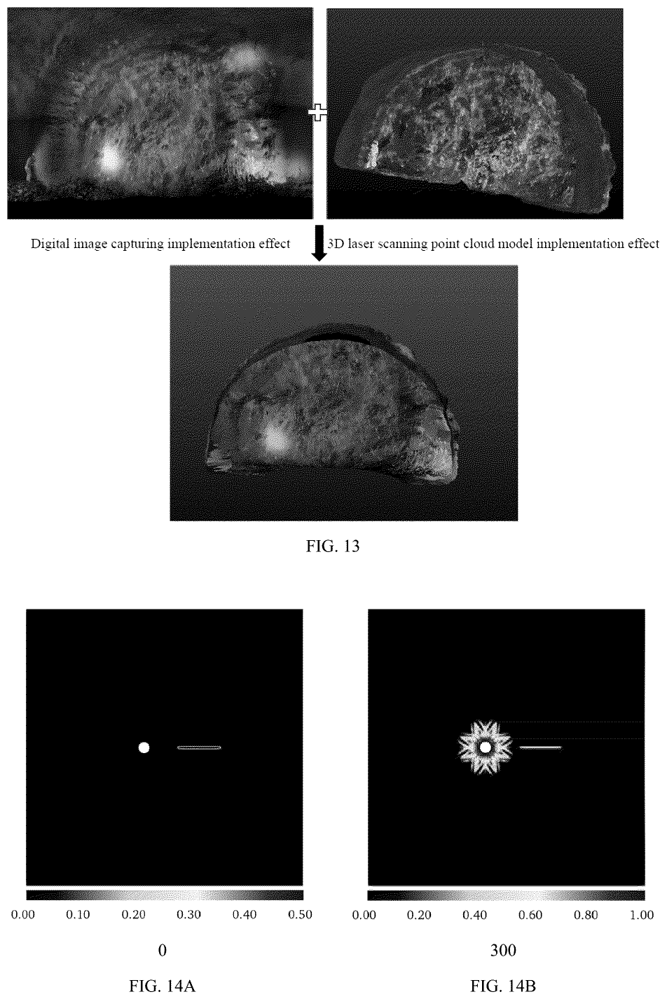

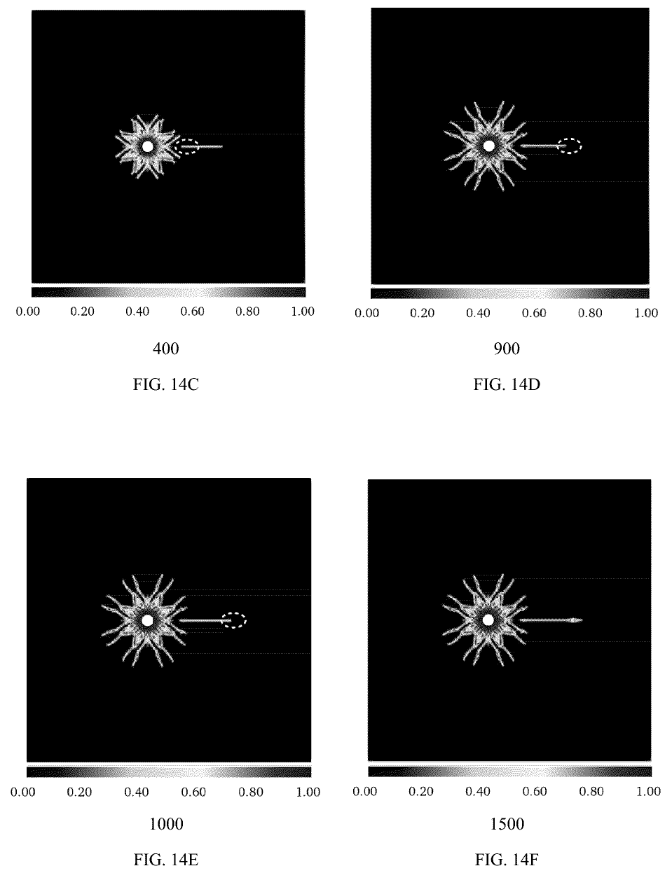

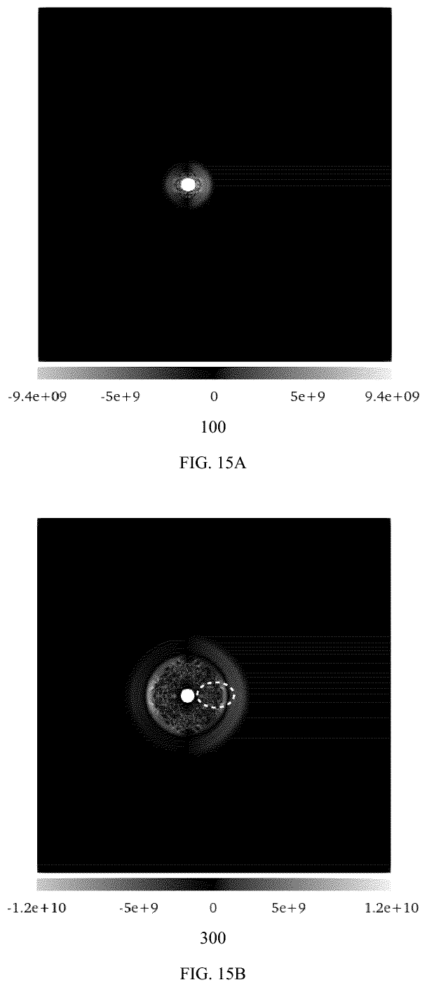

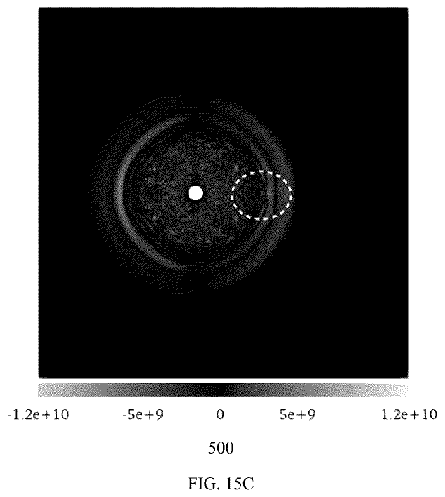

This simulation experiment used on-site data and performed image synthesis on tunnel face image data obtained by the 3D laser scanning device and the digital camera device, as illustrated in FIG. 13, a model of this simulation experiment was established based on blasting parameter information obtained through the tunnel intelligent dynamic blasting design and parameter optimization module. A model size and material parameters of this simulation experiment are as follows. In particular, the model size was 400 mm×400 mm, a borehole radius was 5 mm, and a crack with a length of 60 mm was prefabricated at a distance of 50 mm from a center of the borehole. The material parameters were that: an elastic modulus E=4.5 GPa, a density p=1200 kg/m³, a Poisson's ratio, a material point spacing Δx=1 mm, a domain radius 6=3Δx, a tensile critical elongation scr0=0.0032, and a compression critical elongation scr1=−0.035. FIGS. 14A-14F and FIGS. 15A-15C respectively show fracture propagations and peridynamic distribution cloud images corresponding to different time steps under the action of explosion load. As seen from FIGS. 14A-14F and FIGS. 15A-15C, when the time step is about 300, blasting-induced cracks around the borehole are uniformly distributed, and a near-field force wave reaches the left end of the prefabricated crack and is reflected to form a tensile wave (marked with a white ellipse in the figure); when the time step is about 400, the blasting-induced cracks continue propagating, and near-end cracks propagates to the borehole under the action of a tensile wave; when the time step is about 500, the near-field force wave reaches the right end of the prefabricated crack; when the time step is 900, the blasting-induced cracks stop propagating, and under the action of the prefabricated crack, the wave will be diffracted, and diffraction produces a reflected tensile wave at distal cracks to induce the distal cracks to propagate in a direction facing away from the borehole; and when the time step is 1500, the distal cracks stop propagating. From the numerical simulation result, it can be seen that wing cracks are generated on both sides of the prefabricated crack, and the numerical simulation can capture initiation and arrest of the wing cracks, and a length of the blasting-induced crack on the right side of the borehole (the side where the prefabricated crack is located) is significantly smaller than that on the left side of the borehole, which is basically consistent with the physical test result. It proved that the solution proposed by the invention is feasible and can solve the problems such as lack of professional design software and measurement tools, poor accuracy and low efficiency of borehole layout in a tunnel face.

The above description is only preferred embodiments of the invention, and is not intended to limit implementations and scope of protection of the invention. For those skilled in the art, it should be appreciated that all equivalent substitutions and obvious changes made based on contents of the specification and the accompanying drawings of the invention should be included in the scope of protection of the invention.

What is claimed is:

1. A tunnel dynamic blasting device based on geological body intelligent perception, wherein a blasting design instrument body (1) of the tunnel dynamic blasting device is rotatably mounted on a top end of a pedestal (2), a bottom end of the pedestal (2) is mounted on a four-wheel drive (3), and a lithium battery (4) is secured on the blasting design instrument body (1);
wherein a three-dimensional laser scanning device (202), a digital camera device (203), a borehole locating device (204), a built-in computer (206) and a wireless communication device (207) are disposed in a housing (201) of the blasting design instrument body (1); the three-dimensional laser scanning device (202), the digital camera device (203), the borehole locating device (204) and the wireless communication device (207) are connected to the built-in computer (206); a battery compartment (208) is disposed in the housing (201), and the lithium battery (4) is secured in the battery compartment (208); an electronic screen (205) is disposed outside the housing (201) and connected to the built-in computer (206), and a range finder (209) is mounted above the housing (201).

2. The tunnel dynamic blasting device based on geological body intelligent perception according to claim 1, wherein an incline compensator (210) is mounted at a bottom of the housing (201).

3. A design system of a tunnel dynamic blasting device based on geological body intelligent perception, comprising: a geological body intelligent perception module, a tunnel intelligent dynamic blasting design and parameter optimization module, a blasting dynamic fracture behavior analysis module, a laser scanning blasting effect quality evaluation module and a borehole layout module;
wherein the tunnel intelligent dynamic blasting design and parameter optimization module is individually connected to the geological body intelligent perception module, the blasting dynamic fracture behavior analysis module, the laser scanning blasting effect quality evaluation module and the borehole layout module;
wherein the geological body intelligent perception module is configured to identify a surrounding rock mass;
wherein the tunnel intelligent dynamic blasting design and parameter optimization module is configured to design tunnel blasting parameters and optimize the tunnel blasting parameters according to an evaluation result of the laser scanning blasting effect quality evaluation module;
wherein the blasting dynamic fracture behavior analysis module is configured to perform numerical simulation on the tunnel blasting parameters designed by the tunnel intelligent dynamic blasting design and parameter optimization module and a borehole layout generated by the borehole layout module, to preliminarily check rationality of the tunnel blasting parameters and the borehole layout;
wherein the laser scanning blasting effect quality evaluation module is configured to perform noise reduction and analysis on point cloud data obtained by a three-dimensional laser scanning device in operation to obtain tunnel blasting excavation result, evaluate the tunnel blasting excavation result to obtain the evaluation result, and transmit the evaluation result to the tunnel intelligent dynamic blasting design and parameter optimization module;
wherein the borehole layout module is configured to automatically generate the borehole layout according to a crack of a tunnel face and the tunnel blasting parameters designed by the tunnel intelligent dynamic blasting design and parameter optimization module, and transmit the borehole layout to a projection device;
wherein the geological body intelligent perception module, the tunnel intelligent dynamic blasting design and parameter optimization module, the blasting dynamic fracture behavior analysis module, the laser scanning blasting effect quality evaluation module and the borehole layout module are software modules stored in one or more memories and executable by one or more processors coupled to the one or more memories.

4. The design system of a tunnel dynamic blasting device based on geological body intelligent perception according to claim 3, wherein the geological body intelligent perception module is configured to match explosives according to identified lithologic information of the surrounding rock mass to make a characteristic impedance of the explosives be matched with a characteristic impedance of rock.

5. A blasting method of a tunnel dynamic blasting device based on geological body intelligent perception, comprising:
step 1, acquiring position information of a tunnel face and transmitting the position information to a built-in computer (206), by a blasting design instrument body (1);
step 2, performing three-dimensional laser scanning on the tunnel face to generate a point cloud image of a vicinity of the tunnel face and transmitting information data of the point cloud image to a geological body intelligent perception module in the built-in computer (206), by a three-dimensional laser scanning device (202); performing multi-view based three-dimensional reconstruction on the information data of the point cloud data and inputting surrounding rock information after the reconstruction to a tunnel intelligent dynamic blasting design and parameter optimization module in the built-in computer (206), by the geological body intelligent perception module; acquiring edge features of the tunnel face, determining an identified region as a region of the tunnel face, identifying a type of a surrounding rock mass and joints and cracks of the surrounding rock mass within the tunnel face to obtain identified information and transmitting the identified information to the tunnel intelligent dynamic blasting design and parameter optimization module in the built-in computer (206), by a digital camera device (203);
step 3, selecting corresponding blasting design parameter influence values according to the surrounding rock information, substituting the influence values into a blasting design parameter formula to obtain tunnel blasting design parameters and transmitting the tunnel blasting design parameters to a borehole layout module in the built-in computer (206), by the tunnel intelligent dynamic blasting design and parameter optimization module;
step 4, obtaining a tunnel borehole layout according to the tunnel blasting design parameters and transmitting image information of the tunnel borehole layout to a memory (508) of a borehole locating device (204), by the borehole layout module;
step 5, performing numerical simulation of a blasting process according to the tunnel blasting design parameters obtained by the tunnel intelligent dynamic blasting design and parameter optimization module and the tunnel borehole layout obtained by the borehole layout module, analyzing fracture behaviors of the surrounding rock mass under an action of blasting during the numerical simulation and ensuring fracture development of rock mass in each step during the numerical simulation is in a reasonable range, by a blasting dynamic fracture behavior analysis module in the built-in computer (206);
step 6, generating a borehole layout image according to borehole layout information in the memory (508) and projecting borehole positions on the tunnel face for blasting, by an image controller (509) of the borehole locating device (204); and
step 7, after completion of tunnel blasting and slagging, performing three-dimensional laser scanning on the tunnel face after blasting to obtain a three-dimensional point cloud image after blasting and transmitting the three-dimensional point cloud image to a laser scanning blasting effect quality evaluation module in the built-in computer (206), by the three-dimensional laser scanning device (202); analyzing the three-dimensional point cloud image to obtain tunnel blasting quality result and transmitting the tunnel blasting quality result to the tunnel intelligent dynamic blasting design and parameter optimization module for parameter optimization, by the laser scanning blasting effect quality evaluation module.

6. The blasting method of a tunnel dynamic blasting device based on geological body intelligent perception according to claim 5, wherein in the step 3, the tunnel blasting design parameters comprise: a borehole diameter (d), depths of boreholes (L), a number of boreholes (N), spacings of boreholes, design and layout of boreholes, a powder factor (k), quantity of explosives required for one excavation cycle (Q), and charges of boreholes.

7. The blasting method of a tunnel dynamic blasting device based on geological body intelligent perception according to claim 6, wherein the depths of boreholes comprise: a cut-hole depth L_{ch}, a perimeter-hole depth Lₚₕ, and a reliever-hole depth Lᵣₕ;
a calculation formula of the cut-hole depth L_{ch} is as follows:
$${L}_{ch} = \frac{{L}_{0} / η + 0.2}{sin θ} ,$$
where, L₀ represents a tunnel excavation cyclic footage, η represents an efficiency of borehole, and θ represents an intersection angle between a cut-hole and an excavation face;
a calculation formula of the perimeter-hole depth Lₚₕ is as follows:
$${L}_{ph} = \frac{{L}_{0}}{η \times cos α} ,$$
where α represents an extrapolation angle of perimeter-hole;
a calculation formula of the reliever-hole depth Lᵣₕ is as follows:
$${L}_{rh} = \frac{{L}_{0}}{η} ,$$
a calculation formula of the number of boreholes (N) is as follows:
$$N = 3.3 \sqrt[3]{{fS}^{2}} ,$$
where, N represents the number of boreholes and a calculation result thereof is rounded to be an integer, ƒ represents a firmness coefficient of rock, namely, Protodyakonov's coefficient, ƒ=R_{c}/10, and R_{c} represents a uniaxial saturated compressive strength of rock, S represents an area of tunnel cross-section;
a calculation formula of the powder factor (k) is as follows:
$$k = 1.1 {k}_{0} \sqrt{\frac{f}{S}} ,$$
where, k represents the powder factor, k₀ represents an explosives power correction coefficient, k₀=525/P, and P represents a selected explosives power;
a calculation formula of the quantity of explosives required for one excavation cycle (Q) is as follows:
Q=kSLη,
where, L represents the depths of boreholes;
wherein the charges of boreholes comprise: a single cut-hole charge Q_{schc}, a single perimeter-hole charge Q_{sphc}, and a single reliever-hole charge Q_{srhc};
a calculation formula of the single cut-hole charge Q_{schc} is as follows:
Q_{schc}=rnL_{ch},
where, r represents a weight of a cartridge with a length of 1 meter and is calculated as per cartridge specification of selected explosives, and n represents a charge coefficient of borehole;
a calculation formula of the single perimeter-hole charge Q_{sphc} is as follows:
Q_{sphc}=qₓLₚₕ,
where, qₓ represents a line charge density of perimeter-hole;
a calculation formula of the single reliever-hole charge Q_{srhc} is as follows:
Q_{srhc}=kabLᵣₕ,
where, α represents a hole spacing of reliever-hole, and b represents a row spacing of reliever-hole.

8. The blasting method of a tunnel dynamic blasting device based on geological body intelligent perception according to claim 5, wherein in the step 5, the reasonable range refers to a number of reasonable boreholes accounts for 80%˜100% of a total number of boreholes; each of the reasonable boreholes refers to a borehole that according to impact of a relative position relationship between explosives and the borehole in the blasting process obtained based on a damping coefficient (c) of each the step on a rock mass fracture development process, a development trend of a main crack in each the step is towards a neighboring borehole outside a contour line on which the borehole is located.

9. The blasting method of a tunnel dynamic blasting device based on geological body intelligent perception according to claim 8, wherein a formula for solving the damping coefficient (c) is as follows:
$${c}^{n} = \sqrt[2]{[ {( {u}^{n} )}^{T} {K}^{n} {u}^{n} ] / [ {( {u}^{n} )}^{T} {u}^{n} ]} ,$$
where, u represents a displacement, Kⁿ represents a diagonal local stiffness matrix, and c represents the damping coefficient.
